(19) United States
(12) Patent Application Publication
(10) Pub. No.: US 2022/0405774 A1
(43) Pub. Date: Dec. 22, 2022

(54) SYSTEMS AND METHODS FOR GENERATING PRESCRIPTIVE ANALYTICS

(71) Applicant: ShopperTrak RCT Corporation, Chicago, IL (US)

(72) Inventors: Michael PAOLELLA, Chicago, IL (US); Michelangelo PALELLA, Chicago, IL (US); Amit R. PATIL, Chicago, IL (US); Sanjeev HASIZA, Chicago, IL (US)

(21) Appl. No.: 17/350,607

(22) Filed: Jun. 17, 2021

(51) Int. Cl. G06Q 30/02; G06K 9/00; G06T 7/70; G06Q 10/08

(52) U.S. Cl. CPC G06Q 30/0201; G06K 9/00771; G06T 7/70; G06Q 10/087; G06Q 30/0204

(57) ABSTRACT

Example implementations include a method, apparatus, and computer-readable medium comprising receiving visual data captured by cameras at a store; retrieving one or more pre-defined events related to shopper pose or location; applying data analytics to the visual data, including comparing the visual data with the pre-defined events to identify a sequence of events related to activities of a shopper in relation to an item in an aisle or zone of the store; generating a score based on the events to indicate a likelihood of the shopper completing a purchase transaction of the item at the store; determining, responsive to the score being above a threshold, whether the events indicate that the shopper completed the purchase transaction; identifying, responsive to the score being above the threshold, friction reasons that resulted in the shopper failing to complete the purchase transaction; and generating an alert corresponding to the score or the friction reasons.

### FIELD

The present disclosure relates generally to video analytics systems and methods.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method comprising receiving, by a processor of a computer device, visual data captured by one or more cameras at a store. The method further comprises retrieving, by the processor from a database, one or more pre-defined events related to a shopper pose or location. The method further comprises applying data analytics to the visual data, including comparing the visual data with the one or more pre-defined events to identify a sequence of events related to activities of a shopper in relation to an item in an aisle or zone of the store. The method further comprises generating a score based on the sequence of events, wherein the score is configured to indicate a likelihood of the shopper completing a purchase transaction of the item at the store. The method further comprises determining, responsive to the score being above a threshold, whether the sequence of events indicates that the shopper completed the purchase transaction of the item at the store. The method further comprises identifying, responsive to the score being above the threshold, based on the sequence of events, one or more friction reasons that resulted in the shopper failing to complete the purchase transaction of the item at the store. The method further comprises generating an alert corresponding to the score or the one or more friction reasons.

Another example implementation includes an apparatus comprising a memory and a processor communicatively coupled with the memory. The processor is configured to receive visual data captured by one or more cameras at a store. The processor is further configured to retrieve, from the memory, one or more pre-defined events related to a shopper pose or location. The processor is further configured to apply data analytics to the visual data, including comparing the visual data with the one or more pre-defined events to identify a sequence of events related to activities of a shopper in relation to an item in an aisle or zone of the store. The processor is further configured to generate a score based on the sequence of events, wherein the score is configured to indicate a likelihood of the shopper completing a purchase transaction of the item at the store. The processor is further configured to determine, responsive to the score being above a threshold, whether the sequence of events indicates that the shopper completed the purchase transaction of the item at the store. The processor is further configured to identify, responsive to the score being above the threshold, based on the sequence of events, one or more friction reasons that resulted in the shopper failing to complete the purchase transaction of the item at the store. The processor is further configured to generate an alert corresponding to the score or the one or more friction reasons.

Another example implementation includes an apparatus comprising means for receiving, by a processor of a computer device, visual data captured by one or more cameras at a store. The apparatus further comprises means for retrieving, by the processor from a database, one or more pre-defined events related to a shopper pose or location. The apparatus further comprises means for applying data analytics to the visual data, including comparing the visual data with the one or more pre-defined events to identify a sequence of events related to activities of a shopper in relation to an item in an aisle or zone of the store. The apparatus further comprises means for generating a score based on the sequence of events, wherein the score is configured to indicate a likelihood of the shopper completing a purchase transaction of the item at the store. The apparatus further comprises means for determining, responsive to the score being above a threshold, whether the sequence of events indicates that the shopper completed the purchase transaction of the item at the store. The apparatus further comprises means for identifying, responsive to the score being above the threshold, based on the sequence of events, one or more friction reasons that resulted in the shopper failing to complete the purchase transaction of the item at the store. The apparatus further comprises means for generating an alert corresponding to the score or the one or more friction reasons.

Another example implementation includes a computer-readable medium storing instructions executable by a processor that, when executed, cause the processor to receive visual data captured by one or more cameras at a store. The instructions, when executed, further cause the processor to retrieve, from the memory, one or more pre-defined events related to a shopper pose or location. The instructions, when executed, further cause the processor to apply data analytics to the visual data, including comparing the visual data with the one or more pre-defined events to identify a sequence of events related to activities of a shopper in relation to an item in an aisle or zone of the store. The instructions, when executed, further cause the processor to generate a score based on the sequence of events, wherein the score is configured to indicate a likelihood of the shopper completing a purchase transaction of the item at the store. The instructions, when executed, further cause the processor to determine, responsive to the score being above a threshold, whether the sequence of events indicates that the shopper completed the purchase transaction of the item at the store. The instructions, when executed, further cause the processor to identify, responsive to the score being above the threshold, based on the sequence of events, one or more friction reasons that resulted in the shopper failing to complete the purchase transaction of the item at the store. The instructions, when executed, further cause the processor to generate an alert corresponding to the score or the one or more friction reasons.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example prescriptive analytics system, according to some aspects;

FIG. 2 is a schematic diagram of example weights assigned to various events detected by the prescriptive analytics system in FIG. 2, according to some aspects;

FIG. 3 is a block diagram of an example computing device which may implement all or a portion of the computing device or the camera in FIG. 1 configured for prescriptive analytics, according to some aspects;

FIG. 4 is a block diagram of example components of a computing device which may implement all or a portion of the computing device or the camera in FIG. 1 configured for prescriptive analytics, according to some aspects; and

FIG. 5 is a flow diagram of an example method for prescriptive analytics, according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Some present aspects provide a prescriptive analytics system that analyzes video frames including shopper traffic and/or behavior patterns within a store and provides prescriptive analytics, such as but not limited to intelligence for improving sales per shopper. In an aspect, prescriptive analytics refers to video analytics which may be used to trigger events on one or more other devices.

Turning now to the figures, example aspects are depicted with reference to one or more components described herein, where components in dashed lines may be optional.

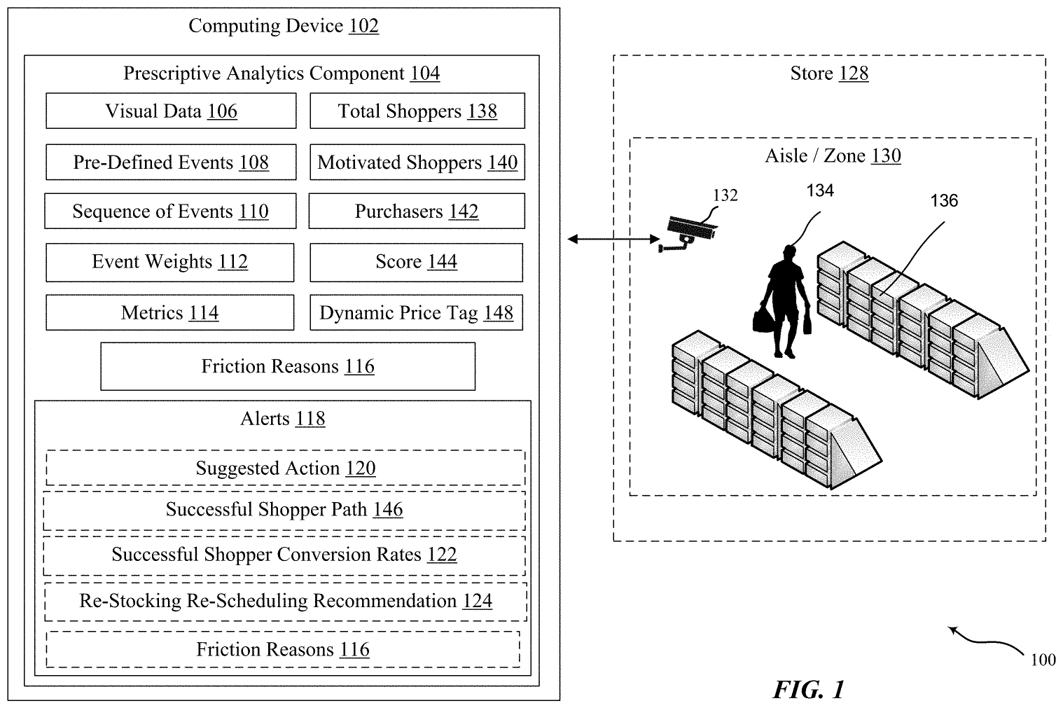

Referring to FIG. 1, in an aspect, a prescriptive analytics system 100 includes a computing device 102 that receives visual data 106 from one or more cameras 132 that monitor the activity of one or more shoppers 134 within an aisle/zone 130 of a store 128. The visual data 106 may include, but is not limited to, one or more video or still image frames. In an aspect, based on the visual data 106, a prescriptive analytics component 104 in the computing device 102 may define/quantify various parameters such as total shoppers 138 (e.g., the number of all visitors to the aisle/zone 130 over a period of time), motivated shoppers 140 (e.g., the number of visitors who exhibit buying behaviors or signals), purchasers 142 (e.g., the number of visitors who result in purchases), etc., and/or provide other prescriptive measures.

In one non-limiting aspect, for example, the prescriptive analytics component 104 may implement vision/artificial intelligence (AI) functionality to identify the number of total shoppers 138 in the aisle/zone 130 by determining how many shoppers 134 enter, pass by, dwell, etc., in the aisle/zone 130.

In one non-limiting aspect, for example, the prescriptive analytics component 104 may implement vision/AI functionality to identify the number of motivated shoppers 140 in the aisle/zone 130 by determining whether the shoppers 134 dwell in the aisle/zone 130 for more than a period of time (e.g., 30 seconds), performing pose or posture detection of the shoppers 134 in the aisle/zone 130, detecting interaction of the shoppers 134 with products in the aisle/zone 130, detecting eye focus of the shoppers 134 in the aisle/zone 130 (e.g., the shoppers 134 looking at the shelves), determining whether the shoppers 134 are alone or in a group of shoppers, assuming that the shoppers 134 are motivated to purchase (with probability=1), etc.

In one non-limiting aspect, for example, the prescriptive analytics component 104 may identify the number of purchasers 142 by determining whether a shopper 134 ended at a point of sale (POS) and completed a transaction, or by implementing vision/AI functionality instead of or in addition to POS data.

In one non-limiting aspect, for example, the prescriptive analytics component 104 may determine the below parameter values (with the listed values being for illustrative purposes only):
Total shoppers=100
Motivated shoppers=50
Purchasers=30

In some aspects, based on these parameter values, for each zone or aisle in the store 128, the prescriptive analytics component 104 may calculate and track sales-related metrics 114 such as:

Total opportunity=Total shoppers*ATS

Lost opportunity=(Total shoppers−Motivated shoppers)*ATS

Lost sales=(Motivated shoppers−Purchasers)*ATS

In an aspect, ATS refers to average transaction size, which is the average value of a transaction averaged over multiple transactions completed by multiple shoppers. For example, in an aspect, ATS may indicate the average transaction value per purchaser.

Based on these metrics 114, the prescriptive analytics component 104 may identify performance of each aisle or zone over a period of time (e.g., hour, day, week, month, etc.), and/or generate prescriptive analytics to improve performance on a per zone or per aisle level.

In one non-limiting aspect, for example, the prescriptive analytics component 104 may categorize one or more “friction” reasons 116 related to why shoppers 134 have not entered the store 128, such as a parking lot being too crowded, parking spaces being too far, an unexpected event happening, etc. In one non-limiting aspect, the prescriptive analytics component 104 may implement AI functionality to categorize these friction reasons 116.

In one non-limiting aspect, for example, the prescriptive analytics component 104 may categorize one or more friction reasons 116 (e.g., at a product display and/or at a POS) related to why motivated shoppers 140 did not make a purchase, such as product unavailability (e.g., color, style, or size unavailability, etc., for example, the size of a shopper versus the sizes in the inventory, a shopper with colorful clothes only saw bland colors, etc.), perception of product quality/fit/style, presentation (e.g., messy display area), knowledge gap, shopper not being able to locate a product, shopper not finding assistance, shopper receiving assistance that is not helpful, shopper only being at the store for research, product price being too high, product price tag or other information is missing, shopper sentiment (e.g., being unhappy with life and/or with sales associate interaction), long lines at POS or fitting room, price error at checkout, gesture or sentiment or cancelled purchase event, theft, etc. In one non-limiting aspect, the prescriptive analytics component 104 may implement AI functionality to categorize these friction reasons 116.

In one non-limiting aspect, for example, for multiple stores (e.g., 500 stores), the analytics generated by the prescriptive analytics component 104 may include total opportunity, lost opportunity, and/or lost sales in each zone or aisle, high friction at display and reason codes, high friction at POS and reason codes, near real-time alerts (e.g., hourly) regarding lost opportunities per aisle/zone, generating alerts for sending a sales associate to a zone and the reasons, providing a predictive playbook on proper labor allocation per aisle/zone, a map to promotion history, an inventory mix and display placement, etc.

In an aspect, for example, the analytics generated by the prescriptive analytics component 104 may be used to provide a predictive playbook that includes a plan or standard operating procedure, for example, for staff allocation, product arrangement, product restocking, etc. For example, if the analytics generated by the prescriptive analytics component 104 indicates that some aisles/zones need more labor/staff, staff allocation may be adjusted to improve successful shopper conversion rate and/or to reduce loss. In one non-limiting aspect, for example, the predictive playbook may include a schedule of staff support per aisle per hour. In an alternative or additional aspect, the predictive playbook may include suggested recommendations for product placement. In one non-limiting aspect, for example, the predictive playbook may indicate that a number of aisles need extra attention and staff during certain times of the day, a number of aisles need to be stocked or even slightly overstocked during certain times of the day, etc.

In an aspect, for example, the analytics generated by the prescriptive analytics component 104 may be used to provide a map to promotion history, which may indicate, for example, whether a promotion resulted in successful shopper conversion, whether a promotion had an impact on shopper journey, etc. In an aspect, for example, the prescriptive analytics component 104 may determine whether a display ad has been detected via video analytics, and identify those display ads that resulted in an improvement. In some aspects, the prescriptive analytics component 104 may use video analytics in addition to POS data to provide a map to promotion history. In an aspect, the prescriptive analytics component 104 may also provide recommendations in near real-time for moving a display ad from a first location to a second location to improve the impact of the display ad and/or to improve successful shopper conversion. In one non-limiting aspect, for example, based on video analytics, the prescriptive analytics component 104 may determine how many people are dwelling in front of the display ad, and then provide a recommendation for moving the display ad to improve exposure of the display ad to shoppers.

In one non-limiting aspect, for example, the prescriptive analytics component 104 may model various scenarios related to shopper location (e.g., enter/exit store zone, enter/exit store, enter/exit product zone, approach/leave shelf, enter/exit fitting zone, enter/exit checkout zone/line), shopper pose (e.g., shopper faces store window, shopper faces shelf, shopper picks up product), shopper-associate interaction (e.g., shopper greets sales associate, shopper looks for sales associate, sales associate intercept (e.g., a sales associate intercepting the shopper), shopper sentiment, shopper eye focus (e.g., shopper looks at product), shopper eye gaze (e.g., shopper gazes at price), shopper location in combination with product radio frequency identification (RFID) information (e.g., leave zone with/without item, enter/leave fitting zone with/without item), etc. In one non-limiting aspect, for example, the prescriptive analytics component 104 may model a scenario related to a sales associate intercepting the shopper at the right time (e.g., within a time period after the shopper arrives at an aisle/zone). In one non-limiting aspect, for example, upon detecting a shopper in an aisle/zone, the prescriptive analytics component 104 may send an alert to an app on a sales associate device to instruct the sales associate to intercept the shopper at that aisle/zone.

In an aspect, for incomplete transactions, the prescriptive analytics component 104 may determine one or more friction reasons 116 such as product out of stock (e.g., size, color, style), unable to find product, product style, product fit, product quality, product price too high and/or different from the price posted on a website or a posted signage, competitor has cheaper product, product price missing, register queue too long, fitting room queue too long, messy product display, shopper needed help that did not arrive, shopper help arrived unfriendly, shopper help arrived but was unhelpful, product price at register higher than expected, etc. Based on these scenarios, the prescriptive analytics component 104 may identify motivated shoppers 140 and determine the reasons why motivated shoppers 140 did not make a purchase.

In one non-limiting implementation, for each shopper 134 that approaches/enters the store 128, the prescriptive analytics component 104 may detect and register a sequence (or list) of events 110, such as, but not limited to, the shopper 134 entering the store 128, the shopper 134 entering the aisle/zone 130 in the store 128, the shopper 134 looking at an item/product 136, the shopper 134 picking up the item/product 136, the shopper 134 looking at their phone, the shopper 134 looking for a sales associate, the shopper 134 leaving the aisle/zone 130 with (or without) the item/product 136, etc. The sequence of events 110 may be defined and customized for a specific store, for example, based on the number of aisles/zones, registers, and/or products in a certain store. The sequence of events 110 may be detected by applying machine learning and image classification techniques to the visual data 106 to identify one or more pre-defined events 108.

In one non-limiting implementation, for example, the machine learning models may include one or more models provided by the Intel OpenVino toolkit, such as object detection models for detecting popular objects (e.g., face detection, person detection, person action recognition (e.g., raising hand), product detection, etc.), object recognition models for classification, regression, and character recognition subsequent to object detection (e.g., age/gender recognition, head pose estimation, emotion recognition, facial landmarks recognition, person attributes recognition, gaze estimation, etc.), re-identification models for tracking of objects/persons, human pose estimation models (estimating a pose based on connecting key points in body skeleton, e.g., ears, eyes, nose, shoulders, knees, etc.), deep learning models (e.g., for image processing, text detection, text recognition, etc.), etc.

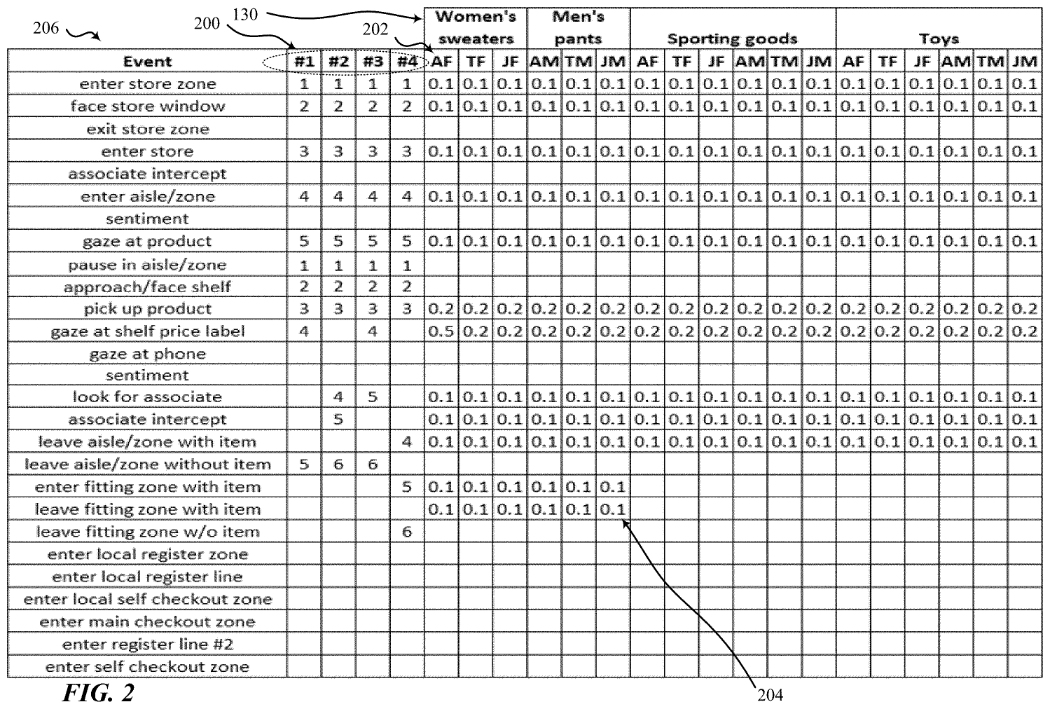

In addition to these models, some present aspects provide models for detection of events related to associate intercept and for detection of events related to acquiring an item, for example, as described below with reference to FIG. 2 and Table 1.

In one non-limiting aspect, for example, the prescriptive analytics component 104 may consider one or more assumptions for generating analytics. For example, the prescriptive analytics component 104 may assume that every event can be detected with a reliable enough model (e.g., 70% reliable), and/or assume that re-identification models have sufficient reliability and reach across an aisle or retail layout.

In one non-limiting aspect, for example, a number of shoppers may approach/enter a number of stores in a district (e.g., a town) over a time period (e.g., a day). Each store may have a certain layout with aisles/zones that include certain products. In this case, the prescriptive analytics component 104 may detect a number of possible patterns/paths that are taken by shoppers at these stores. For example, in one such patterns/paths, a shopper may gaze at an item and then leave. The prescriptive analytics component 104 may detect, record, and track such patterns/paths for each shopper at each aisle/zone at each store, and analyze such patterns/paths to generate metrics 114 related to successful shopper conversion journey (e.g., for converting shoppers 134 to purchasers 142).

Referring to FIGS. 1 and 2, the prescriptive analytics component 104 may define a number of possible shopper journeys 200, where each shopper journey 200 includes a number of events 206. Each of the events may be detected using a machine learning model, for example, as indicated in Table 1 below.

TABLE 1
Example Events and Corresponding Models
Used for Detecting the Events

| Event | Model |
|---|---|
| enter store zone | person detection |
| face store window | pose estimation |
| exit store zone | person detection |
| enter store | person detection |
| associate intercept | associate intercept detection |
| enter aisle/zone | person detection |
| sentiment | emotions recognition |
| gaze at product | head/pose estimation |
| pause in aisle/zone | person detection |
| approach/face shelf | head/pose estimation |
| pick up product | item acquire detection |
| gaze at shelf price label | head/pose estimation |
| gaze at phone | head/pose estimation |
| sentiment | emotions recognition |
| look for associate | head/pose estimation |
| associate intercept | associate intercept detection |
| leave aisle/zone with item | item acquire detection |
| leave aisle/zone without item | item acquire detection |
| enter fitting zone with item | item acquire detection |
| leave fitting zone with item | item acquire detection |
| leave fitting zone w/o item | item acquire detection |
| enter local register zone | person detection |
| enter local register line | person detection |
| enter local self-checkout zone | person detection |
| enter main checkout zone | person detection |
| enter register line #2 | person detection |
| enter self-checkout zone | person detection |

In one non-limiting aspect, for each shopper journey 200 of each customer category 202 (e.g., adult female (AF), teen female (TF), juvenile female (JF), adult male (AM), teen male (TM), juvenile male (JM), etc.) in each aisle/zone 130 (e.g., women's sweaters, men's pants, sporting goods, toys etc.), the prescriptive analytics component 104 may assign a weight 204 to each detected event 206, and use the weights 204 to generate a score 144 that indicates whether a shopper that took the shopper journey was a motivated shopper. For example, in one non-limiting example, the prescriptive analytics component 104 may add the weights 204 of the detected events 206 for a shopper journey of a shopper at an aisle/zone to determine the score 144, and if the score 144 is greater than a threshold score (e.g., 0.5), the prescriptive analytics component 104 may indicate that the shopper was a motivated shopper. In some aspects, the weights 204 may be determined by reviewing historical data, and the prescriptive analytics component 104 may adjust the weights 204 across various shoppers based on, for example, gender, age, height, weight, or other categories/classifications.

In some aspects, the prescriptive analytics component 104 may correlate sales associate engagement with successful shopper conversion (conversion of a shopper to a purchaser). For example, the prescriptive analytics component 104 may determine the number of shoppers, time spent per shopper, whether sales associate engagement resulted in shopper conversion (e.g., 70% of engaged customers were converted), individual sales associate effectiveness, any difference by region/store, sales associate engagement report friction reasons, etc.

In an aspect, for each unsuccessful conversion of a shopper, the prescriptive analytics component 104 may determine one or more friction reasons 116 based on the sequence of events 110 detected for that shopper. For example, if the sequence of events 110 includes the shopper checking a price of an item and then leaving the store, the prescriptive analytics component 104 may indicate a friction reason of “the item price being too high.” In another example, if the sequence of events 110 includes the shopper looking for help but no help comes and the shopper leaves, the prescriptive analytics component 104 may indicate a friction reason of “no help available.” In another example, if the sequence of events 110 includes the shopper looking for help and help comes but the shopper leaves, the prescriptive analytics component 104 may indicate a friction reason of “help was unhelpful.” In another example, if the sequence of events 110 includes the shopper looking for an item in an aisle/zone that is blocked due to re-stocking and then the shopper leaves, the prescriptive analytics component 104 may indicate a friction reason of “re-stocking needs to be rescheduled for a different time.” The re-stocking may be determined by performing, for example, large object recognition in the visual data 106 of the aisle/zone 130.

In an alternative or additional aspect, the prescriptive analytics component 104 may determine the friction reason 116 based on an explicit reason indicated and entered into a device (e.g., a handheld device carried by a shopper or a sales associate, a stationary device installed at the aisle/zone or at a monitoring room or an exit point of the store) by a shopper and/or by a sales associate.

In an aspect, the prescriptive analytics component 104 may generate, record, transmit, and/or display alerts 118 (e.g., notifications, recommendations, etc.) in near real-time based on the metrics 114 derived related to shopper activity. For example, in one non-limiting aspect, the prescriptive analytics component 104 may send alerts 118 such as “90% of shoppers are leaving the fitting zone without an item,” “the fitting zone is crowded.” “80% of shoppers are leaving the battery aisle without an item,” “a shopper at aisle 2 needs help,” etc.

In an aspect, the prescriptive analytics component 104 may generate, record, transmit, and/or display a bar chart, a heat map, or a shopper journey graph based on the metrics derived related to shopper activity. For example, the prescriptive analytics component 104 may display a near real-time bar chart of successful shopper conversion rates 122 per aisle/zone. Each data point in the bar chart may represent an aisle/zone in a single store. Alternatively, each data point in the bar chart may represent aggregated data over a same aisle/zone across multiple stores. The bar chart may be used to identify underperforming aisles/zones at a store in near real-time, in order to alleviate the reasons for underperforming, e.g., the aisle/zone being messy, no helpful sales associate available at the aisle/zone, etc.

In an alternative or additional example, the prescriptive analytics component 104 may graphically display a successful shopper path 146 (or journey) within a store, where the successful shopper path 146 represents a repeated path or sequence of events 110 that was repeated by multiple purchasers 142 over a period of time (e.g., a day).

In an alternative or additional example, the alerts 118 output by the prescriptive analytics component 104 may include a suggested action 120 for queue management, for example, by identifying areas of the store where a shopper queue has formed.

In an alternative or additional example, the suggested action 120 may be related to energy efficiency/usage, for example, by controlling air-conditioning, lighting, etc., at an aisle/zone based on shopper activity at that aisle/zone. For example, if the prescriptive analytics component 104 determines that an aisle/zone is not busy between 6:00 PM and 8:00 PM, the lights at that aisle/zone may be dimmed down between 6:00 PM and 8:00 PM.

In an alternative or additional example, the prescriptive analytics component 104 may generate a dynamic price tag 148 for an item. For example, if the prescriptive analytics component 104 determines unsuccessful shopper conversion due to a friction reason such as an item price being too high, the item price may be adjusted/lowered to improve the likelihood of shopper conversion.

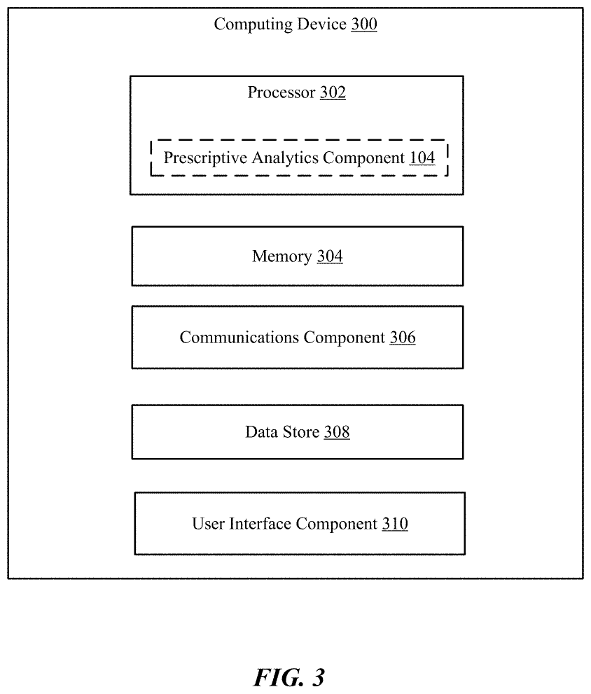

FIG. 3 illustrates an example block diagram providing details of computing components in a computing device 300 that may implement all or a portion of one or more components in the computing device 102, camera 132, or any other component described above. The computing device 300 includes a processor 302 which may be configured to execute or implement software, hardware, and/or firmware modules that perform any functionality described above with reference to one or more components in the computing device 102, camera 132, or any other component described above. For example, the processor 302 may be configured to execute the prescriptive analytics component 104 to provide prescriptive analytics functionality, as described herein with reference to various aspects.

The processor 302 may be a micro-controller and/or may include a single or multiple set of processors or multi-core processors. Moreover, the processor 302 may be implemented as an integrated processing system and/or a distributed processing system. The computing device 300 may further include a memory 304, such as for storing local versions of applications being executed by the processor 302, related instructions, parameters, etc. The memory 304 may include a type of memory usable by a computer, such as random access memory (RAM), read only memory (ROM), tapes, flash drives, magnetic discs, optical discs, volatile memory, non-volatile memory, and any combination thereof. Additionally, the processor 302 and the memory 304 may include and execute an operating system executing on the processor 302, one or more applications, display drivers, etc., and/or other components of the computing device 300.

Further, the computing device 300 may include a communications component 306 that provides for establishing and maintaining communications with one or more other devices, parties, entities, etc., utilizing hardware, software, and services. The communications component 306 may carry communications between components on the computing device 300, as well as between the computing device 300 and external devices, such as devices located across a communications network and/or devices serially or locally connected to the computing device 300. For example, the communications component 306 may include one or more buses, and may further include transmit chain components and receive chain components associated with a wireless or wired transmitter and receiver, respectively, operable for interfacing with external devices.

Additionally, the computing device 300 may include a data store 308, which can be any suitable combination of hardware and/or software, that provides for mass storage of information, databases, and programs. For example, the data store 308 may be or may include a data repository for applications and/or related parameters not currently being executed by the processor 302. In addition, the data store 308 may be a data repository for an operating system, application, display driver, etc., executing on the processor 302, and/or one or more other components of the computing device 300.

The computing device 300 may also include a user interface component 310 operable to receive inputs from a user of the computing device 300 and further operable to generate outputs for presentation to the user (e.g., via a display interface to a display device). The user interface component 310 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 310 may include one or more output devices, including but not limited to a display interface, a speaker, a haptic feedback mechanism, a printer, any other mechanism capable of presenting an output to a user, or any combination thereof.

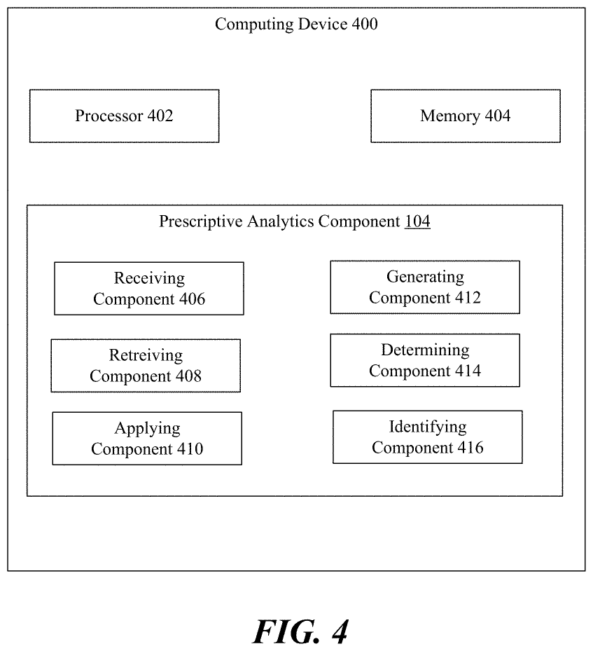

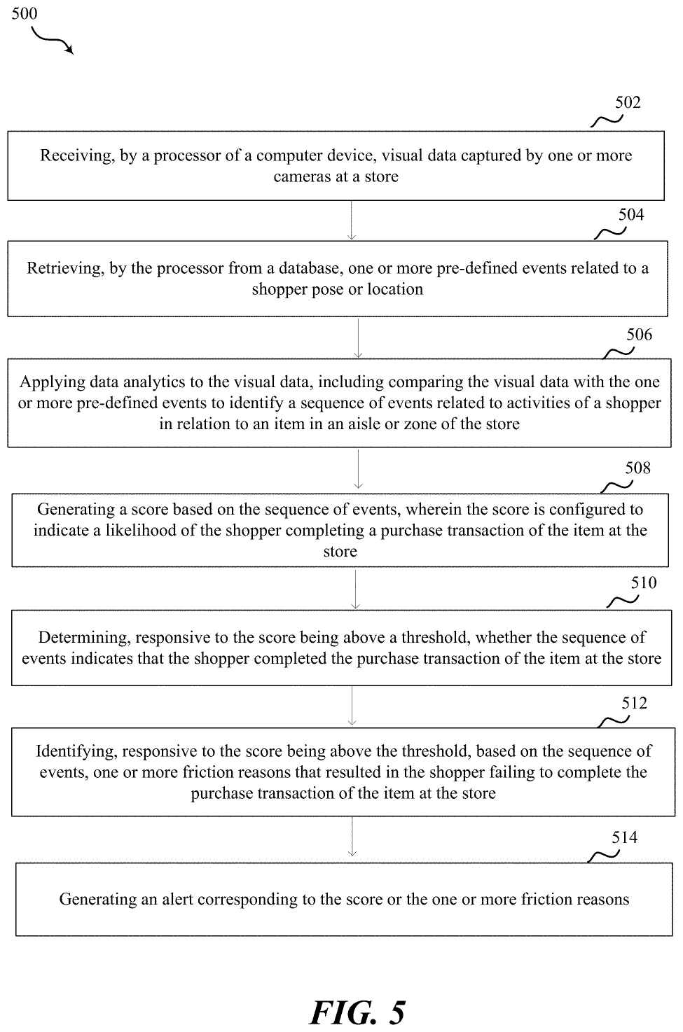

Referring to FIGS. 4 and 5, in operation for prescriptive analytics functionality, computing device 400 may implement at least a portion of one or more components in FIGS. 1-3 above, such as all or at least a portion of the computing device 102 in FIG. 1, and may perform method 500 such as via execution of prescriptive analytics component 104 by processor 402 and/or memory 404. Specifically, computing device 400 may be configured to perform method 500 for performing an aspect of prescriptive analytics functionality, as described herein. It should be noted that computing device 400, processor 402, and memory 404 may be the same or similar to computing device 300, processor 302, and memory 304 as described above with respect to FIG. 3.

At block 502, the method 500 includes receiving, by a processor of a computer device, visual data captured by one or more cameras at a store. For example, in an aspect, computing device 400, processor 402, memory 404, prescriptive analytics component 104, and/or receiving component 406 may be configured to or may comprise means for receiving, by a processor of a computer device, visual data captured by one or more cameras at a store.

For example, in an aspect, the receiving at block 502 may include the computing device 102 executing the receiving component 406 to receive the visual data 106 captured by the cameras 132 at the store 128.

At block 504, the method 500 includes retrieving, by the processor from a database, one or more pre-defined events related to a shopper pose or location. For example, in an aspect, computing device 400, processor 402, memory 404, prescriptive analytics component 104, and/or retrieving component 408 may be configured to or may comprise means for retrieving, by the processor from a database, one or more pre-defined events related to a shopper pose or location.

For example, in an aspect, the retrieving at block 504 may include the computing device 102 executing the retrieving component 408 to retrieve, from the memory 404 or another data store or database, one or more pre-defined events 108 related to a shopper pose or location.

At block 506, the method 500 may include applying data analytics to the visual data, including comparing the visual data with the one or more pre-defined events to identify a sequence of events related to activities of a shopper in relation to an item in an aisle or zone of the store. For example, in an aspect, computing device 400, processor 402, memory 404, prescriptive analytics component 104, and/or applying component 410 may be configured to or may comprise means for applying data analytics to the visual data, including comparing the visual data with the one or more pre-defined events to identify a sequence of events related to activities of a shopper in relation to an item in an aisle or zone of the store.

For example, in an aspect, the applying at block 506 may include the computing device 102 executing the applying component 410 to apply data analytics to the visual data 106, including comparing the visual data 106 with the one or more pre-defined events 108 to identify a sequence of events 110 related to activities of a shopper 134 in relation to an item/product 136 in an aisle or zone 130 of the store 128.

At block 508, the method 500 may include generating a score based on the sequence of events, wherein the score is configured to indicate a likelihood of the shopper completing a purchase transaction of the item at the store. For example, in an aspect, computing device 400, processor 402, memory 404, prescriptive analytics component 104, and/or generating component 412 may be configured to or may comprise means for generating a score based on the sequence of events, wherein the score is configured to indicate a likelihood of the shopper completing a purchase transaction of the item at the store.

For example, in an aspect, the generating at block 502 may include the computing device 102 executing the generating component 412 to generate a score 144 based on the sequence of events 110, wherein the score 144 is configured to indicate a likelihood of the shopper 134 completing a purchase transaction of the item/product 136 at the store 128. In one non-limiting aspect, the score 144 may be used to determine whether the shopper 134 may be categorized as a motivated shopper, for example, based on whether the score is greater than a threshold. In one non-limiting implementation, the threshold may be a configurable threshold. For example, the threshold may be configured differently based on shopper demographics. For example, shoppers of different ages/genders may have different shopping habits/behaviors that indicate different levels of interest in a product, and the threshold may be configured accordingly to take into account age/gender-specific shopper behavior. In an aspect, for example, multiple thresholds may be implemented per individual store for different shopper demographics. For example, different thresholds may be defined/implemented for a store, including a threshold for adult females, a threshold for juvenile females, a threshold for teen females, a threshold for adult males, a threshold for juvenile males, a threshold for teen males, etc.

At block 510, the method 500 may include determining, responsive to the score being above a threshold, whether the sequence of events indicates that the shopper completed the purchase transaction of the item at the store. For example, in an aspect, computing device 400, processor 402, memory 404, prescriptive analytics component 104, and/or determining component 414 may be configured to or may comprise means for determining, responsive to the score being above a threshold, whether the sequence of events indicates that the shopper completed the purchase transaction of the item at the store.

For example, in an aspect, the determining at block 502 may include the computing device 102 executing the determining component 414 to determine, responsive to the score 144 being above a threshold (e.g., being greater than 0.5), whether the sequence of events 110 indicates that the shopper 134 completed a purchase transaction of the item/product 136 at the store 128.

At block 512, the method 500 may include identifying, responsive to the score being above the threshold, based on the sequence of events, one or more friction reasons that resulted in the shopper failing to complete the purchase transaction of the item at the store. For example, in an aspect, computing device 400, processor 402, memory 404, prescriptive analytics component 104, and/or identifying component 416 may be configured to or may comprise means for identifying, responsive to the score being above the threshold, based on the sequence of events, one or more friction reasons that resulted in the shopper failing to complete the purchase transaction of the item at the store.

For example, in an aspect, the identifying at block 512 may include the computing device 102 executing the identifying component 416 to identify, responsive to the score 144 being above the threshold (e.g., being greater than 0.5), based on the sequence of events 110, one or more friction reasons 116 that resulted in the shopper 134 failing to complete the purchase transaction of the item/product 136 at the store 128.

At block 514, the method 500 may include generating an alert corresponding to the score or the one or more friction reasons. For example, in an aspect, computing device 400, processor 402, memory 404, prescriptive analytics component 104, and/or generating component 412 may be configured to or may comprise means for generating an alert corresponding to the score or the one or more friction reasons.

For example, in an aspect, the generating at block 514 may include the computing device 102 executing the generating component 412 to generate an alert 118 corresponding to the score 144 or the one or more friction reasons 116. For example, in one non-limiting implementation, the computing device 102 may send a report/alert to a tablet device of a sales associate or other personnel based upon configurable thresholds to indicate that no one is picking up items in an aisle/zone on a certain day.

In one optional implementation, the alert 118 may indicate a suggested action 120 to increase the likelihood of the shopper 134 completing the purchase transaction of the item/product 136 at the store 128.

In one optional implementation, the alert 118 may indicate a suggested action 120 to improve energy efficiency at the aisle/zone 130 based on shopper activity. For example, the alert 118 may indicate an energy efficiency action to leverage energy effectively based on shopper journey/pathing options (e.g., dim the lights in aisles that do not have patterns of high shopper traffic during certain days).

In one optional implementation, the alert 118 may include a graph of successful shopper conversion rates 122 per aisle or zone, wherein the successful shopper conversion rates 122 indicate what percentage of shoppers in an aisle or zone completed a transaction.

In one optional implementation, the alert 118 may indicate a friction reason 116 related to formation of a queue at the store 128. The alert 118 may also indicate a queue management action such as opening and closing of check lanes.

In one optional implementation, the alert 118 may indicate a friction reason 116 related to a blockage of the aisle/zone 130 by shopper traffic.

In one optional implementation, the alert 118 may indicate a friction reason 116 related to a blockage of the aisle/zone by.

In one optional implementation, the alert 118 may further indicate a re-scheduling recommendation 124 for re-stocking the aisle/zone 130.

In one optional implementation, the alert 118 may indicate a pattern or path taken by one or more shoppers at the store 128.

In one optional implementation, applying the data analytics at block 506 may further include providing the visual data 106 to a machine learning model that is configured and trained to identify the one or more pre-defined events 108.

In one optional implementation, generating the score 144 at block 508 comprises assigning a weight 112 to each event in the sequence of events 110 and adding weights 112 of the sequence of events 110.

In one optional implementation, generating the score 144 at block 508 further comprises assigning the weight 112 to each event based on one or more of a demographic category of the shopper 134 or a product category of the aisle/zone 130.

Some further example aspects are provided below.

1. A method comprising:

receiving, by a processor of a computer device, visual data captured by one or more cameras at a store;

retrieving, by the processor from a database, one or more pre-defined events related to a shopper pose or location;

applying data analytics to the visual data, including comparing the visual data with the one or more pre-defined events to identify a sequence of events related to activities of a shopper in relation to an item in an aisle or zone of the store;

generating a score based on the sequence of events, wherein the score is configured to indicate a likelihood of the shopper completing a purchase transaction of the item at the store:

determining, responsive to the score being above a threshold, whether the sequence of events indicates that the shopper completed the purchase transaction of the item at the store;

identifying, responsive to the score being above the threshold, based on the sequence of events, one or more friction reasons that resulted in the shopper failing to complete the purchase transaction of the item at the store; and

generating an alert corresponding to the score or the one or more friction reasons.

2. The method of clause 1, wherein the alert indicates a suggestion for an action to increase the likelihood of the shopper completing the purchase transaction of the item at the store.

3. The method of any of the above clauses, wherein the alert indicates a suggestion for an action to improve energy efficiency at the aisle or zone based on shopper activity.

4. The method of any of the above clauses, wherein the alert includes a graph of successful shopper conversion rates per aisle or zone, wherein the successful shopper conversion rates indicate what percentage of shoppers in an aisle or zone completed a transaction.

5. The method of any of the above clauses, wherein the alert indicates a friction reason related to formation of a queue at the store.

6. The method of any of the above clauses, wherein the alert indicates a friction reason related to blockage of the aisle or zone by shopper traffic.

7. The method of any of the above clauses, wherein the alert indicates a friction reason related to a blockage of the aisle or zone by re-stocking equipment or personnel.

8. The method of any of the above clauses, wherein the alert further indicates a re-scheduling recommendation for re-stocking the aisle or zone.

9. The method of any of the above clauses, wherein the alert indicates a pattern or path taken by one or more shoppers at the store.

10. The method of any of the above clauses, wherein applying the data analytics comprises providing the visual data to a machine learning model that is configured and trained to identify the one or more pre-defined events.

11. The method of any of the above clauses, wherein generating the score comprises assigning a weight to each event in the sequence of events and adding weights of the sequence of events.

12. The method of any of the above clauses, wherein generating the score further comprises assigning the weight to each event based on one or more of a demographic category of the shopper or a product category of the aisle or zone.

An apparatus comprising:

a memory; and

a processor communicatively coupled with the memory and configured to perform the method of any of the above clauses.

A non-transitory computer-readable medium storing instructions executable by a processor that, when executed, cause the processor to perform the method of any of the above clauses.

An apparatus comprising means for performing the method of any of the above clauses.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A. B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism.” “element.” “device.” and the like may not be a substitute for the word “means.” As such, no claim element is to be construed as a means plus function unless the element is expressly recited using the phrase “means for.”

What is claimed is:

1. A method comprising:
receiving, by a processor of a computer device, visual data captured by one or more cameras at a store;
retrieving, by the processor from a database, one or more pre-defined events related to a shopper pose or location;
applying data analytics to the visual data, including comparing the visual data with the one or more pre-defined events to identify a sequence of events related to activities of a shopper in relation to an item in an aisle or zone of the store;
generating a score based on the sequence of events, wherein the score is configured to indicate a likelihood of the shopper completing a purchase transaction of the item at the store;
determining, responsive to the score being above a threshold, whether the sequence of events indicates that the shopper completed the purchase transaction of the item at the store;
identifying, responsive to the score being above the threshold, based on the sequence of events, one or more friction reasons that resulted in the shopper failing to complete the purchase transaction of the item at the store; and
generating an alert corresponding to the score or the one or more friction reasons.

2. The method of claim 1, wherein the alert indicates a suggestion for an action to increase the likelihood of the shopper completing the purchase transaction of the item at the store.

3. The method of claim 1, wherein the alert indicates a suggestion for an action to improve energy efficiency at the aisle or zone based on shopper activity.

4. The method of claim 1, wherein the alert includes a graph of successful shopper conversion rates per aisle or zone, wherein the successful shopper conversion rates indicate what percentage of shoppers in an aisle or zone completed a transaction.

5. The method of claim 1, wherein the alert indicates a friction reason related to formation of a queue at the store.

6. The method of claim 1, wherein the alert indicates a friction reason related to a blockage of the aisle or zone by shopper traffic.

7. The method of claim 1, wherein the alert indicates a friction reason related to a blockage of the aisle or zone by re-stocking equipment or personnel.

8. The method of claim 7, wherein the alert further indicates a re-scheduling recommendation for re-stocking the aisle or zone.

9. The method of claim 1, wherein the alert indicates a pattern or path taken by one or more shoppers at the store.

10. The method of claim 1, wherein applying the data analytics comprises providing the visual data to a machine learning model that is configured and trained to identify the one or more pre-defined events.

11. The method of claim 1, wherein generating the score comprises assigning a weight to each event in the sequence of events and adding weights of the sequence of events.

12. The method of claim 11, wherein generating the score further comprises assigning the weight to each event based on one or more of a demographic category of the shopper or a product category of the aisle or zone.

13. An apparatus comprising:
a memory; and
a processor communicatively coupled with the memory and configured to:
receive visual data captured by one or more cameras at a store;
retrieve, from a database, one or more pre-defined events related to a shopper pose or location;
apply data analytics to the visual data, including comparing the visual data with the one or more pre-defined events to identify a sequence of events related to activities of a shopper in relation to an item in an aisle or zone of the store;
generate a score based on the sequence of events, wherein the score is configured to indicate a likelihood of the shopper completing a purchase transaction of the item at the store;
determine, responsive to the score being above a threshold, whether the sequence of events indicates that the shopper completed the purchase transaction of the item at the store;
identify, responsive to the score being above the threshold, based on the sequence of events, one or more friction reasons that resulted in the shopper failing to complete the purchase transaction of the item at the store; and
generate an alert corresponding to the score or the one or more friction reasons.

14. The apparatus of claim 13, wherein the alert indicates a suggestion for an action to increase the likelihood of the shopper completing the purchase transaction of the item at the store.

15. The apparatus of claim 13, wherein the alert indicates a suggestion for an action to improve energy efficiency at the aisle or zone based on shopper activity.

16. The apparatus of claim 13, wherein the alert includes a graph of successful shopper conversion rates per aisle or zone, wherein the successful shopper conversion rates indicate what percentage of shoppers in an aisle or zone completed a transaction.

17. The apparatus of claim 13, wherein the alert indicates a friction reason related to formation of a queue at the store.

18. The apparatus of claim 13, wherein the alert indicates a friction reason related to a blockage of the aisle or zone by shopper traffic or by re-stocking equipment or personnel.

19. The apparatus of claim 13, wherein the alert indicates a pattern or path taken by one or more shoppers at the store.

20. A non-transitory computer-readable medium storing instructions executable by a processor that, when executed, cause the processor to:
receive visual data captured by one or more cameras at a store;
retrieve, from a database, one or more pre-defined events related to a shopper pose or location;
apply data analytics to the visual data, including comparing the visual data with the one or more pre-defined events to identify a sequence of events related to activities of a shopper in relation to an item in an aisle or zone of the store;
generate a score based on the sequence of events, wherein the score is configured to indicate a likelihood of the shopper completing a purchase transaction of the item at the store;
determine, responsive to the score being above a threshold, whether the sequence of events indicates that the shopper completed the purchase transaction of the item at the store;
identify, responsive to the score being above the threshold, based on the sequence of events, one or more friction reasons that resulted in the shopper failing to complete the purchase transaction of the item at the store; and
generate an alert corresponding to the score or the one or more friction reasons.
